(19) United States
(12) Patent Application Publication
(10) Pub. No.: US 2015/0143087 A1
(43) Pub. Date: May 21, 2015

(54) SERVICE SYSTEM AND METHOD

(71) Applicant: General Electric Company, Schenectady, NY (US)

(72) Inventors: Dustin Ross Garvey, Oakland, CA (US); Nicholas Edward Roddy, Schenectady, NY (US); Christopher M. McQuown, Erie, PA (US)

(73) Assignee: General Electric Company, Schenectady, NY (US)

(21) Appl. No.: 14/086,523

(22) Filed: Nov. 21, 2013

(51) Int. Cl. G06F 9/30

(52) U.S. Cl. CPC G06F 9/30181
USPC 712/226

(57) ABSTRACT

A system includes provision of a first set of instructions associated with a product to a user of the product, the user having one or more associated characteristics, reception of a revision to the first set of instructions from the user, determination of whether to modify the first set of instructions based the revision and on the characteristics, and modification, if a determination is made to modify the first set of instructions, of the first set of instructions based at least in part on the revision to generate a second set of instructions.

### BACKGROUND

1. Technical Field

Embodiments of the invention relate to service and maintenance systems and methods.

2. Discussion of Art

Products and services sold to users may be accompanied by corresponding instructional materials. Such materials may include instruction booklets, user manuals, troubleshooting guides, repair manuals, and other materials. A user service department may receive input from users regarding the instructional materials associated with a certain product. A responsible employee may review the input to determine that the materials should be revised. Thusly-revised instructional materials may then be included with future shipments of the product. In some cases, the revised instructional materials may be mailed, posted on a product website, or otherwise delivered to existing users.

It may be desirable to have a product or system that differs from those that are currently available.

### BRIEF DESCRIPTION

In some embodiments, a method includes receiving from one or more users of a product a revision to a first set of instructions associated with the product. The user is associated with one or more characteristics. The first set of instructions may be modified based at least in part on the revision to generate a second set of instructions associated with the product.

In some embodiments, a controller receives, from one or more users of a product, a revision to a first set of instructions associated with the product. The user is associated with one or more characteristics. The first set of instructions may be modified based at least in part on the revision to generate a second set of instructions associated with the product.

### BRIEF DESCRIPTION OF THE DRAWINGS

FIG. 1 is a block diagram of a computing system according to some embodiments.

FIG. 2 is a tabular representation of an instruction table according to some embodiments.

FIG. 3 is a tabular representation of a user table according to some embodiments.

FIG. 4 is a flow diagram of an operation according to some embodiments.

FIG. 5 is an outward view of a user interface according to some embodiments.

FIG. 6 is an outward view of a user interface according to some embodiments.

FIG. 7 is an outward view of a user interface according to some embodiments.

FIG. 8 is a tabular representation of a user table according to some embodiments.

FIG. 9 is a tabular representation of an instruction table according to some embodiments.

FIG. 10 is a tabular representation of a user table according to some embodiments.

FIG. 11 is a tabular representation of a user table according to some embodiments.

FIG. 12 is a tabular representation of an instruction table according to some embodiments.

FIG. 13 is a tabular representation of a user table according to some embodiments.

FIG. 14 is a tabular representation of an instruction table according to some embodiments.

FIG. 15 illustrates a network architecture of a system according to some embodiments.

FIG. 16 is a block diagram of a computing system according to some embodiments.

### DESCRIPTION

Some embodiments of the invention relate to service and maintenance systems and processes. These systems and processes may include documentation or records associated with servicing, using, maintaining at least one process or system. Users may suggest modifications or changes to the documentation or records. These suggested modifications may be incorporated and/or disseminated out to the plurality or crowd of users. Some embodiments of the invention may relate to aspects of how such modifications are received, compared, used, selected or rejected, disseminated or displayed, and the like.

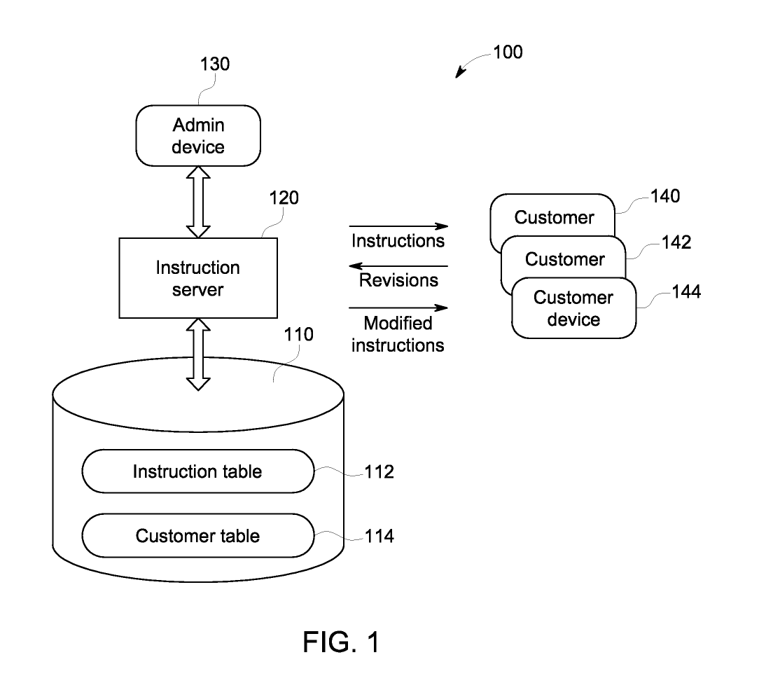

FIG. 1 represents a logical architecture for describing systems, while other implementations may include more or different components arranged in other manners. In FIG. 1, a system 100 includes a data storage device 110, an instruction server 120, and an administrative device 130. The data storage device may include any one or more data storage devices that are or become known. Examples of data storage device include, but are not limited to, a fixed disk, an array of fixed disks, and volatile memory (e.g., Random Access Memory).

The data storage device implements system for storing structured data, unstructured data or both structured and unstructured data. The data storage device may include databases and operating protocols. Suitable databases may include an object oriented database, a relational database, and a multi-dimensional database. Suitable protocols may conform to eXtendable Markup Language (XML). For example, the data storage device may implement a structured-query language (SQL) relational database management system including include persistent storage (e.g., one or more fixed disks) for storing a persistent database and volatile storage for storing recently-used data.

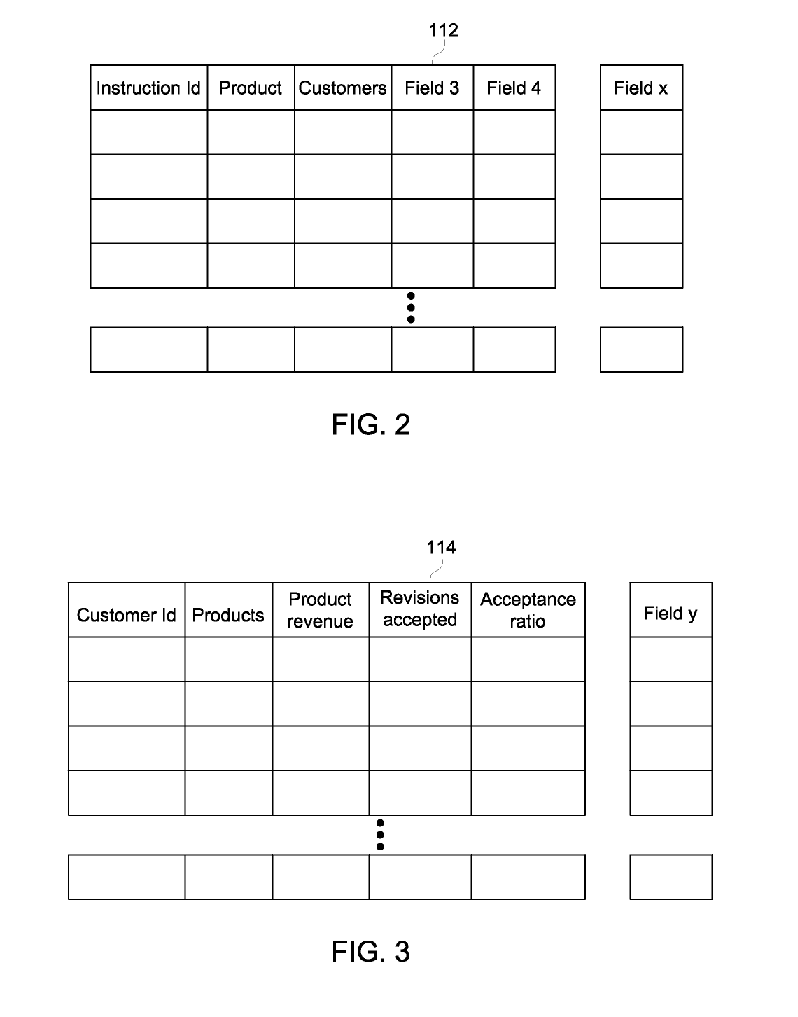

The data storage device includes information in the form of an instruction table 112 and a user table 114. The instruction table and the user table may each include one or more relational database tables. The data of instruction table and user table may be received from a source that can be application specific. For example, the data of user table may be received from a Customer Relationship Management (CRM) system in communication with the system. Examples of instruction table and user table according to some embodiments will be described below with respect to FIGS. 2 and 3.

The instruction server 120 may include one or more computing devices executing program code to operate as described herein. The instruction server may execute, for example, an application to transmit instructions to users, to receive revisions to the instructions from users, and to automatically determine whether to accept the revisions. This determination may be based on the revisions and/or on characteristics of the user from whom the revisions were received. If it is determined to accept the revisions, the instructions may be modified based on the revisions and transmitted to users. Modifications may be made automatically, may be run manually, may have one or more conditional logic gates associated with their activation, and may be interactive with one or more external inputs.

The instruction server 120 may interface with external devices (e.g., administrative device 130) to access, insert and/or modify data of instruction table. The instruction server may transmit queries to the data storage device and, in response, receive data therefrom in order to execute commands received from external devices. The instruction server may be implemented by processor-executable program code executed by one or more processors, which may or may not be located in a same chassis as the data storage device.

The administrative device 130 may include one or more devices executing program code for presenting user interfaces to allow interaction with The instruction server. Presentation of a user interface may include any degree or type of rendering, depending on the coding of the user interface. For example, the administrative device may include a desktop computer executing a Web Browser to receive a Web page or equivalent (e.g., in HTML format) from the instruction server, and may render and present the Web page according to known protocols. In one embodiment, the administrative device may present user interfaces by executing a standalone executable file (e.g., an .exe file) or code (e.g., a JAVA applet) within a virtual machine.

Intermediate devices, systems and/or software applications may reside between the administrative device, The instruction server, and the data storage device, and one or more of these devices, systems and/or applications may execute one or more of the functions attributed to the instruction server herein.

Suitable user devices 140 through 144 may receive, present and transmit data. User device examples may include a desktop computer, a laptop computer, a tablet computer, and a smartphone. User devices may communicate with the instruction server via any one or more communication protocols and communication networks. For example, such communication may conform to HyperText Transport Protocol, File Transfer Protocol, and/or any Software-as-a-Service protocol.

FIG. 2 is a tabular representation of a portion of instruction table according to some embodiments. Instruction table includes several records, with each record being associated with a set of instructions and including several (i.e., x) fields. In the illustrated example, the fields include Instruction ID, Product, and Users. The Instruction ID field includes an identifier associated with a set of instructional materials. The instructional materials associated with a particular identifier may be stored in the data storage device or elsewhere. According to the illustrated example, the “_#” suffix of each Instruction ID indicates a version number of the associated instructional materials.

The Product field specifies the product or products to which the associated instructional materials pertain. A product may include a product or service, and any given product may be associated with more than one record of instruction table. For example, a product may be associated with a first record corresponding to a user manual, a second record corresponding to a first set of repair instructions, a third record corresponding to a second set of repair instructions, and a fourth record corresponding to a set of troubleshooting instructions. The User field associates a set of instructions with one or more users of a plurality or crowd of users. The User field may indicate users to whom the set of instructions have been delivered. Users may be specified in the User field using a User ID, which may be a key to a table such as user table.

FIG. 3 is a tabular representation of a portion of user table according to some embodiments. User table includes several records, with each record being associated with a user and including several (i.e., y) fields. The User ID field includes an identifier specifying a particular user, which may be an individual, organization, etc. depending on the particular implementation. The Products field indicates Products which the user has purchased or with which the user is otherwise associated. For example, in a case that the user is a repair facility, the Products field may indicate those products which the user is authorized to repair.

The Product Revenue field indicates an amount of revenue attributable to the user. The Product Revenue field may indicate a total amount of product sales to the user, or any other suitable metric or combination of metrics which indicates an amount of revenue attributable to the user. The Product Revenue field may further indicate other features or characteristics of the user. For example, an ‘importance” of the user to the entity implementing the system, or delinquency data, or other aspects for which information about the user may be useful. This characterization may be used to determine a weighting for suggested revisions received from that user. Other fields may supplement with additional evaluation criteria.

The Revisions Accepted field tracks a number of revisions which were received from the user and accepted for incorporation into corresponding instructions, as will be described below. Similarly, the Acceptance Ratio field indicates a ratio of revisions received from the user and accepted to revisions received from the user. Examples illustrating the usage and updating of the Revisions Accepted and Acceptance Ratio fields according to some embodiments are provided below.

The Revisions Accepted and Acceptance Ratio fields each provide metrics which might be useful in determining whether future revisions received from a user should be accepted. In this regard, the fields may provide insight as to the “quality” of revisions received from a particular user. Embodiments may employ any fields and/or metrics for use in making this determination.

Embodiments are not limited to the fields shown in FIGS. 2 and 3. The records of instruction table and user table may be received from one or disparate sources, and the data of any single record may be received from one or more sources. Instruction table and user table may be stored in data source according to any protocol that is or becomes known.

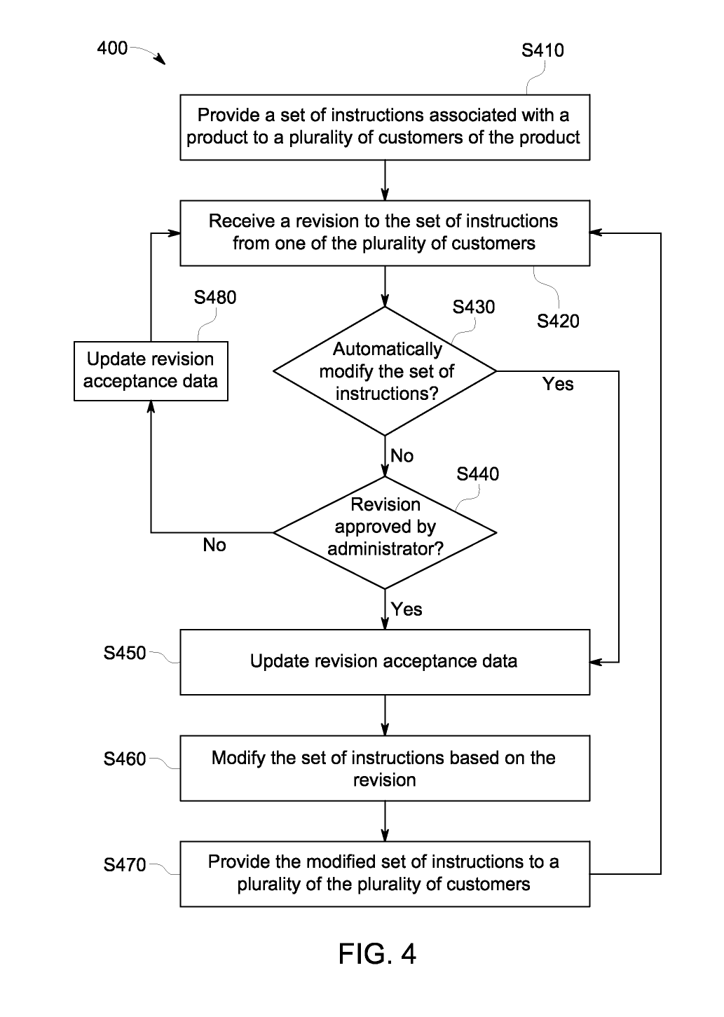

FIG. 4 includes a flow diagram of a process 400 according to some embodiments. In some embodiments, various hardware elements (e.g., a processor) of the instruction server execute program code to perform that process. The process and other processes mentioned herein may be embodied in processor-executable program code read from one or more non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S410, a set of instructions associated with a product is provided to each of a plurality of users associated with the product. The process concerns a set of instructions for a particular product. Other instances of the process may be executed in parallel for other instructions associated with the particluar product and/or other products.

As described above, the set of instructions may include one or more of instruction booklets, user manuals, troubleshooting guides, repair manuals, and other materials. The set of instructions may be provded to different users at different times. For example, the set of instructions may be included within packaging of the product, and therefore provided to each of the plurality of users upon purchase.

The set of instructions may be embodied in hardcopy, electronic or other form. The form and delivery method of the set of instructions may differ among the plurality of users. As such, the set of instructions may be provided to the plurality of users via mail (e.g., hardcopy and/or CD-ROM), electronic transmission (email, electronic download, Web page, etc.), or a combination thereof

According to some embodiments, one or both of instruction table and user table may be modified and/or used during S410. In the former regard, a user may be added to the Users field associated with an Instruction ID in a table if a set of instructions associated with that Instruction ID is provided to the user (e.g., upon purchase of the associated product) at S410. In the latter, one or more users associated with a particular product may be identified from table, a set of instructions associated with that product may be identified from table, and the set of instructions may be provided to the identified one or more users.

After S410, a plurality of users of a given product are in possession of a particular set of instructions associated with the given product. Next, at S420, a revision to the set of instructions is received from one of the plurality of users. The revision may be generated and received in any suitable manner According to some embodiments, a user operates one of user devices 140-144 to transmit a revision to the instruction server, where the revision is received at S420.

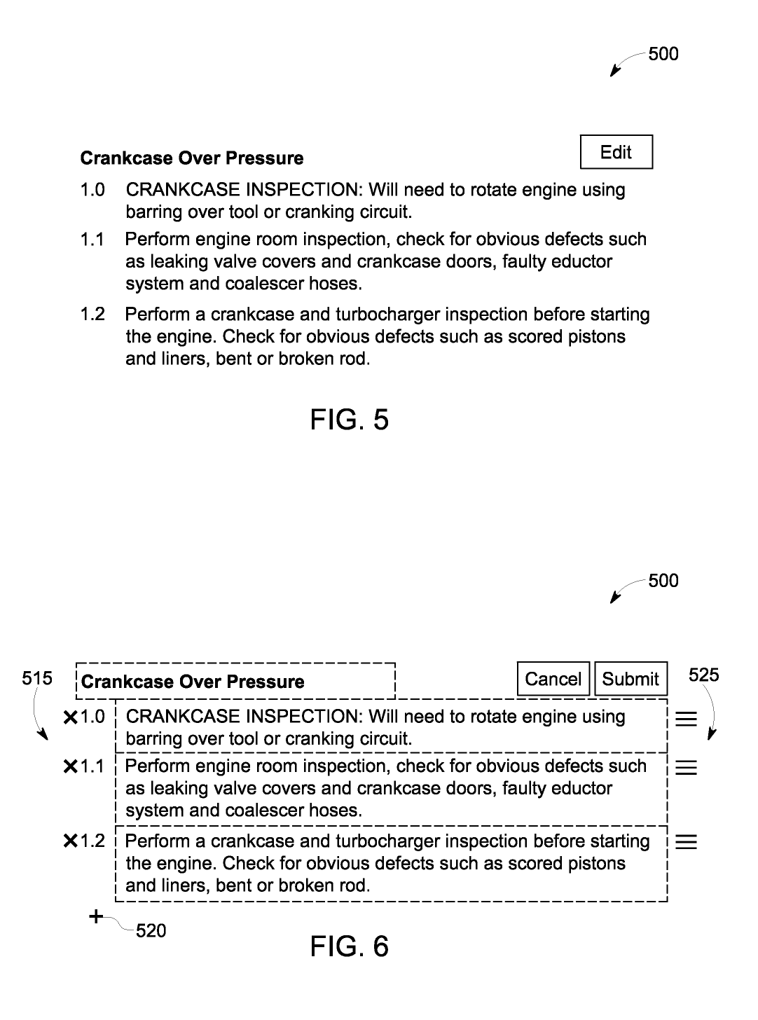

FIGS. 5 through 7 illustrate a graphical user interface which may be used by a user to revise a set of instructions according to some embodiments. In the present example, user interface 500 of FIG. 5 presents a set of instructions for responding to a “Crankcase Over Pressure” alert received from a combustion engine control system.

FIG. 6 illustrates user interface 500 after selection of Edit button 510. FIG. 6 shows controls which are usable to rearrange, add, remove, and edit the steps of the set of instructions according to some embodiments. One of controls 515 may be selected to delete its corresponding step, control 520 may be selected to add a step, and one of controls 525 may be selected to edit the text of its corresponding step. Embodiments are not limited to user interfaces such as user interface 500 and the controls thereof

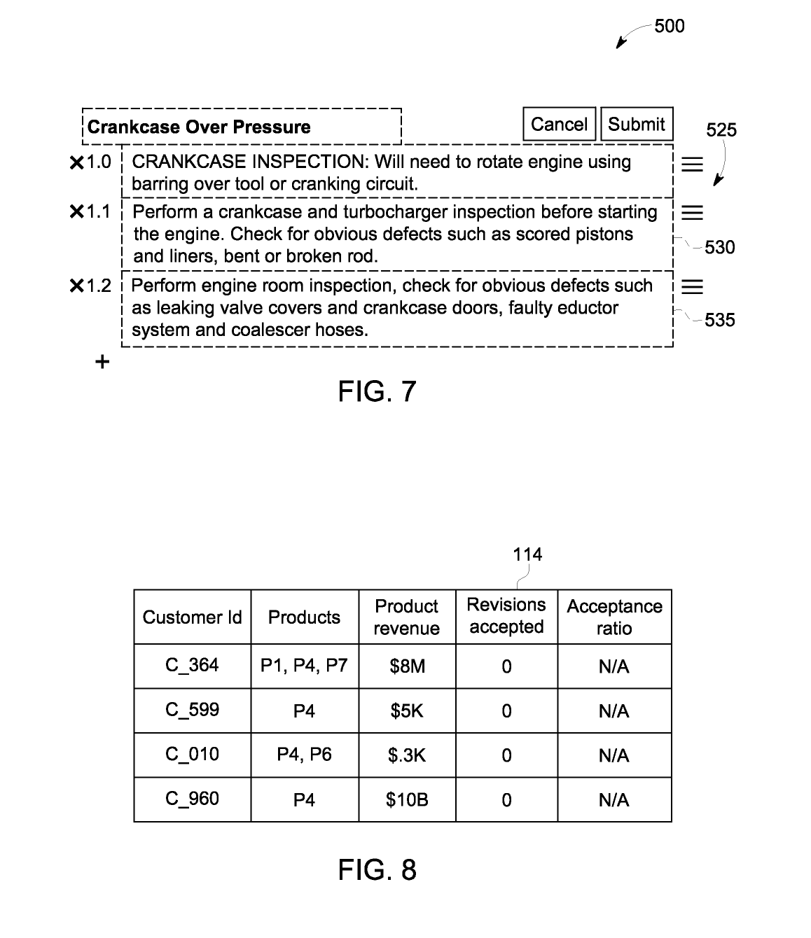

FIG. 7 illustrates revisions to a set of instructions using user interface 500. A user has selected controls 525 associated with steps 1.1 and 1.2 in order to edit the text of these steps. Again, revisions according to some embodiments may include one or more of rearranging, adding, removing, and editing instructions.

It will be assumed that the revision of FIG. 7 is received at S420. At S430, it is determined whether to automatically modify the set of instructions based on the received revision. This determination may be based on the instructions, the revision, and/or the user according to some embodiments. Several examples of this determination are provided below, and embodiments are not limited to the examples.

According to one example, the determination at S430 includes determining whether the revision has been received before, and whether the number of prior submissions of the revision is greater than a threshold number. Such a determination assumes that the popularity of a revision is related to its suitability for inclusion in the set of instructions.

In another example, the determination at S430 includes determining whether the revision is a revision of instruction sequence and not a revision of instruction content. In this regard, a revision of instruction sequence might be less likely to require review than a revision of instruction content.

Any of the criteria discussed herein with respect to S430 may be used, in any combination, in embodiments of S430. For example, S430 may consist of a multi-prong determination, in which satisfaction of any (or two or more, or three or more, etc.) of several different criteria (each of which may evaluate one or more factors) may result in an affirmative determination at S430.

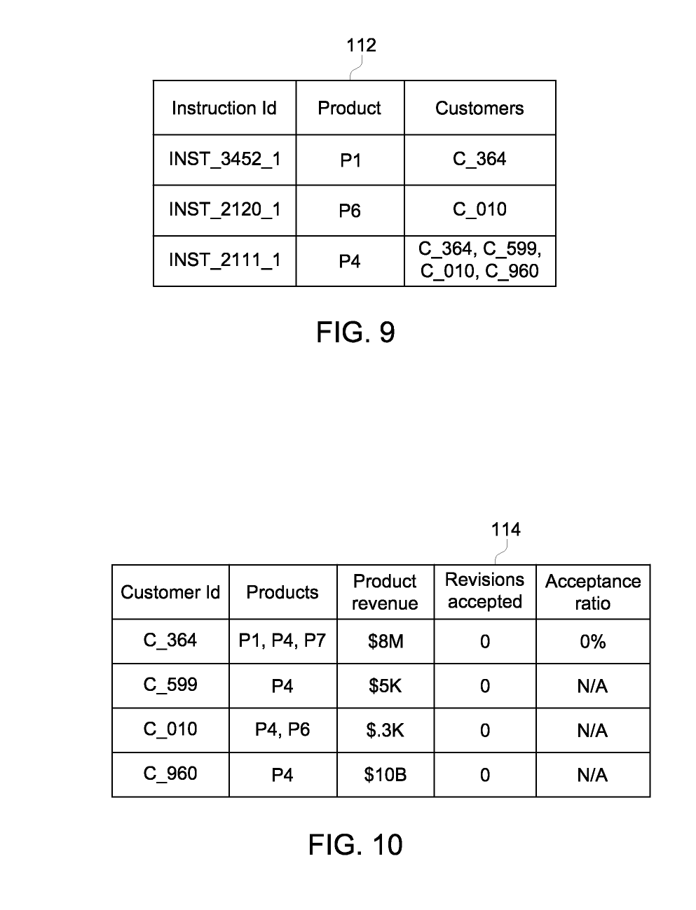

FIG. 8 illustrates a populated portion of user table and FIG. 9 illustrates a populated portion of instruction table for purposes of an example of S430 according to some embodiments. The value of the Acceptance Ratio field of user table is N/A for each User Id, therefore FIG. 8 indicates that no revisions have been received from any of the listed users.

According to an initial example, the revision of FIG. 7 is received at S420 from user C_{—}364. The revision is associated with product P4. At S430, one or more criteria may be applied in order to determine whether to automatically modify the corresponding set of instructions based on the revision. For example, the determination at S430 may be affirmative if the user from whom the revision was received is associated with an acceptance ratio above a threshold, with a number of accepted revisions above a threshold, and/or with a total product revenue above a threshold. Some embodiments may implement any combination of one or more criteria.

In an example, it may be assumed that the determination is negative because the number of accepted revisions received from user C_{—}364 is less than 50 and the total revenue associated with user C_{—}364 is less than $10 Million. Again, embodiments may implement any suitable combination of criteria and thresholds. Flow therefore proceeds to S440.

An administrator (e.g., operating administrator device 130) reviews the revision at S440. It will be assumed that the administrator does not approve of the revision. Accordingly, revision acceptance data is updated at S480 and flow returns to S420.

FIG. 10 illustrates user table with updated revision acceptance data according to the present example. In particular, the acceptance ratio associated with user C_{—}364 has been updated to 0%. The Revisions Accepted field has not been updated because the received revision was not accepted.

After returning to S420, another revision to the set of instructions is received from a user. For example, a revision is received from user C_{—}599. Again, it is determined that the applicable criteria are not met at S430. However, the revision is approved by the administrator at S440.

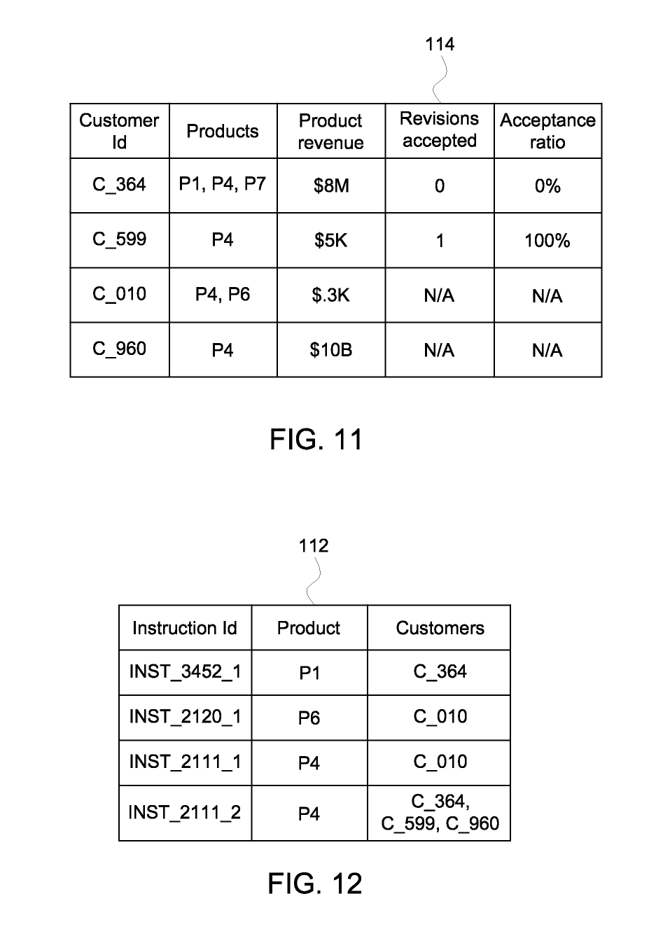

Corresponding revision acceptance data is updated at S450. FIG. 11 illustrates user table with updated revision acceptance data according to the present example. As shown, the Revisions Accepted field associated with user C_{—}599 now includes the value “1”, and the Acceptance Ratio field includes 100%.

Next, at S460, the set of instructions is modified based on the accepted revision. The modified instructions are provided to a plurality of the plurality of users at S470.

Instruction table of FIG. 11 includes a new row associated with modified instructions INST_{—}2111_{—}2. Instructions INST_{—}2111_{—}2 are associated with product P4 and are a revised version of instructions INST_{—}2111_{—}1. Instruction table of FIG. 11 shows that users C_{—}364, C_{—}599 and C_{—}960 are associated with instructions INST_{—}2111_{—}2 but that user C_{—}010 remains associated with instructions INST_{—}2111_{—}1. This is intended to illustrate that the modified set of instructions might not be provided to all the users who received the original set of instructions at S410.

For example, some users may have previously indicated a desire to not receive updated instructions, or might not have paid a fee required to receive additional instructions. Some users may fail to meet other criteria, such as those described above, which determines whether the users are to receive sets of instructions which may be modified as described herein.

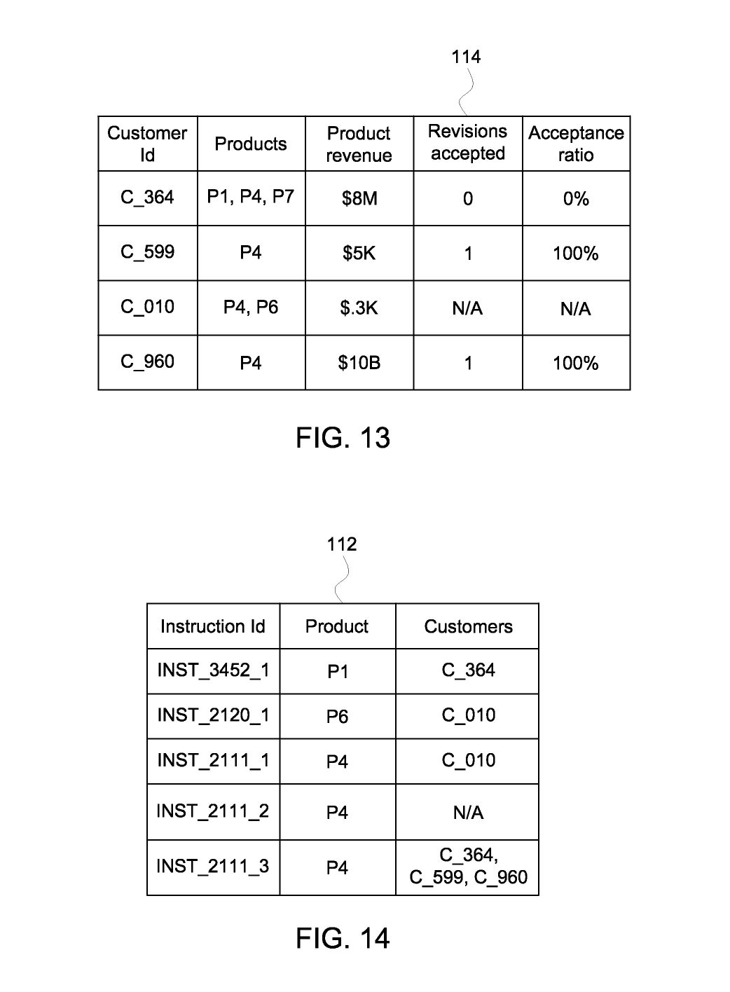

Flow returns to S420 from S470. A revision is received from user C_{—}960 at S420 and flow proceeds to S430. The revision is a revision to instructions INST_{—}2111_{—}2, which were previously provided to user C_{—}960 at S470. At S430, and according to the present example, it is determined to automatically modify the set of instructions based on the value of the Product Revenue field associated with user C_{—}960. The revision acceptance data is then updated at S450 as shown in FIG. 13.

Next, the set of instructions is modified at S460 based on the accepted revision, and the modified instructions are provided to a plurality of the plurality of users at S470. In this regard, instruction table of FIG. 14 includes a new row associated with modified instructions INST_{—}2111_{—}3. Instructions INST_{—}2111_{—}3 are associated with product P4 and users C_{—}364, C_{—}599 and C_{—}960. User C_{—}010 remains associated with instructions INST_{—}2111_{—}1.

The process may continue to receive revised instructions, determine whether they should be automatically applied based on criteria and on the data of user table, and to update the data of user table based on the determination. Accordingly, some embodiments may provide an efficient and self-regulating system for automatic acceptance of revisions.

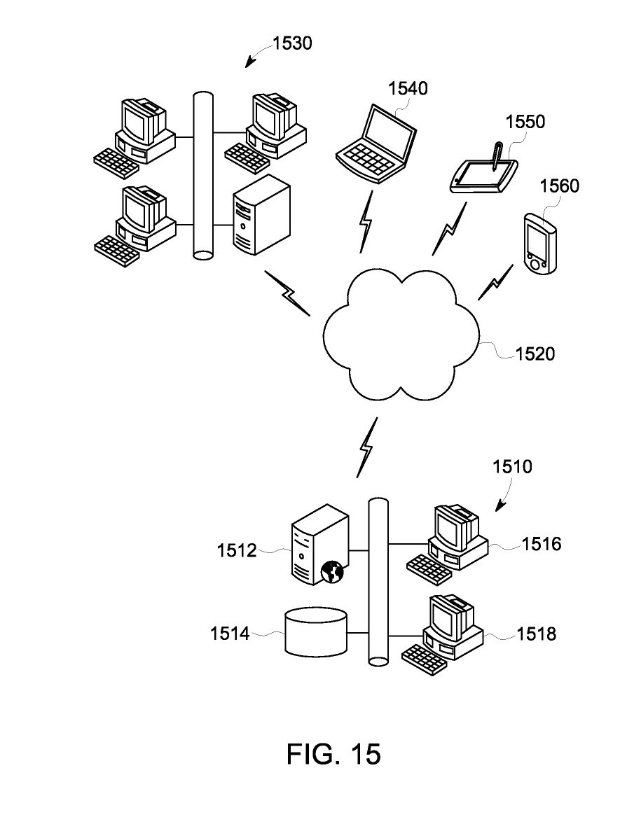

FIG. 15 is an overview of an instance of hardware architecture according to some embodiments. For example, network 1510 may be operated by a product-selling entity implementing process 400. Network 1510 includes server 1512 which may include a Web server and the instruction server as described above. Database 1514 may include instruction table and user table, as well as sets of instructions according to some embodiments. Computing devices 1516 and 1518 may be operated to administer process 400 as described herein, to write sets of instructions, and/or to perform any operations which are useful in the course of business. Server 1512, database 1514, and devices 1516 and 1518 may therefore operate as described herein to execute process 400 according to some embodiments.

Network 1510 communicates with World Wide Web 1520 and, in turn, with network 1530 and devices 1540-1560. Any of network 1530 and devices 1540-1560 may implement one or more of user devices 140-144 of system 100. In this regard, any of network 1530 and devices 1540-1560 may receive sets of instructions, revise the sets of instructions, provide revisions to network 1510, and receive revised sets of instructions from network 1510. According to some embodiments, network 1530 is operated by a company which is a user of one or more products sold by the company of network 1510, while devices 1540-1560 are operated by individuals who also happen to be users of these products.

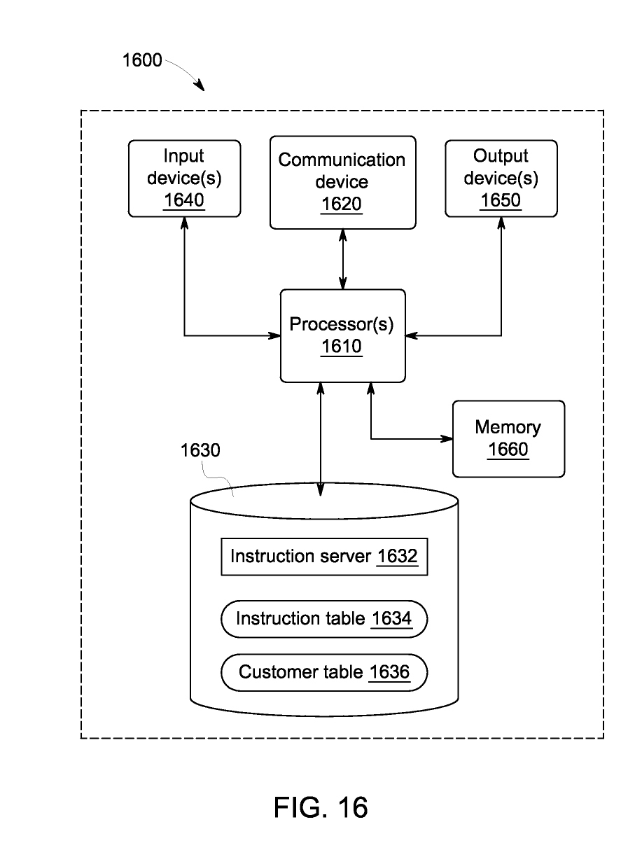

FIG. 16 is a block diagram of system 1600 according to some embodiments. System 1600 may include a general-purpose computing system and may execute program code to perform any of the processes described herein. System 1600 may include an implementation of the data storage device and the instruction server according to some embodiments. System 1600 may include other unshown elements according to some embodiments.

System 1600 includes one or more processors 1610 operatively coupled to communication device 1620, data storage device 1630, one or more input devices 1640, one or more output devices 1650 and memory 1660. Communication device 1620 may facilitate communication with external devices, such as a reporting client, or a data storage device. Input device(s) 1640 may include, for example, a keyboard, a keypad, a mouse or other pointing device, a microphone, knob or a switch, an infra-red (IR) port, a docking station, and/or a touch screen. Input device(s) 1640 may be used, for example, to enter information into apparatus 1600. Output device(s) 1650 may include, for example, a display (e.g., a display screen) a speaker, and/or a printer.

Data storage device 1630 may include any appropriate persistent storage device, including combinations of magnetic storage devices (e.g., magnetic tape, hard disk drives and flash memory), optical storage devices, Read Only Memory (ROM) devices, etc., while memory 1660 may include Random Access Memory (RAM).

Instruction server 1632 may include program code executed by processor(s) 1610 to cause computing system 1600 to perform any one or more of the processes described herein. Embodiments are not limited to execution of these processes by a single apparatus.

Data storage device 1630 stores instruction table 1634 and user table 1636, which may be configured and utilized as described herein. Data storage device 1630 may also store sets of instructions referenced in instruction table 1634 and as described herein. Data storage device 1630 may store other data and other program code for providing additional functionality and/or which are necessary for operation of system 1600, such as device drivers, operating system files, etc.

A technical effect is to provide improved generation of revised materials.

In one example, a troubleshooting process is related to a crankcase over pressure fault. After ensuring the fault cause is not engine related, a first instruction set may indicate that the turbocharger is to be inspected. Replacement of the turbocharger may entail a large expense. A subsequent step of the first instruction set may indicate the fault cause is an eductor tube that allows air to escape the crankcase. The eductor tube may cause substantially less than the turbocharger. The fix, then, would entail the cost of the high and low dollar parts. A user may submit a revision that indicates the eductor should be changed out prior to the turbocharger. If this fixes the fault, the cost of the turbocharger may be saved. Alternatively, if time rather than cost is a driving factor, a user may submit a revision that replacing both the turbocharger and the eductor tube may be replaced simultaneously as they are both located in the same area of an engine. Although the cost to the service is higher than the first approach, the product or asset may be put into service more quickly. Classifying the revisions, and the subsequent instruction sets based on those revisions, may allow users to select a repair or maintenance instruction set that reflects their priorities.

Continuing the above-example, subsequent users may review the first instruction set and/or the second and subsequent instruction sets. The system may accept rating information about the various instruction sets, and the rating information may be searchable and/or sortable. The users may indicate relative satisfaction and/or dissatisfaction with each instruction set. This rating information may be used to weight and/or highlight various ones of the instructions sets. That is, an instruction set with more positive votes or “likes” may be featured more prominently than another. Alternatively, or additionally, an instruction set based on a revision from a user with a particular associated characteristic may be given preference or deference over another. In a practical example, if an identified industry expert suggests a revision that may be both more likely to generate a modified second instruction set but it also may enhance the prominence of that resulting modified set.

The modified second instruction sets may replace the first instruction sets entirely, or may be supplementary in their display and use. Such may appear as “see more” or “see alternative approach” selections that are displayed in response to activating an icon (or in the case of written form, turning to an indicated page).

In one embodiment, the submitted revision includes warnings, actions to avoid or situations that represent difficulty or danger. These second instruction sets may be layered over the first instruction set, and may be place at the front of the steps (to warn about issues at the onset) or may be placed in the instruction set proximate to the specific activity related to the warning.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. A person of ordinary skill in the relevant art may recognize other embodiments may be practiced with modifications and alterations to that described above.

What is claimed is:

1. A method, comprising:
receiving, from one or more users of a product , a revision to a first set of instructions associated with the product, the user having one or more associated characteristics; and
modifying the first set of instructions based at least in part on the revision to generate a second set of instructions associated with the product.

2. The method of claim 1, further comprising determining to modify the first set of instructions based at least in part on the one or more associated characteristics.

3. The method of claim 2, wherein determining to modify the first set of instructions includes one or more of:
determining whether a number of accepted revisions associated with the user is greater than a threshold number;
determining whether a number of prior submissions of the revision is greater than a threshold number;
determining whether the revision includes a revision of instruction sequence and not a revision of instruction content; and
determining whether a revision acceptance ratio associated with the user is greater than a threshold ratio.

4. The method of claim 1, further comprising receiving rating information on the second set of instructions from one or more of a plurality of users.

5. The method of claim 4, wherein the second set of instructions is one of a plurality of modified sets of instructions created from a plurality of revisions provided by users, and each modified set of instructions of the plurality is configured to display corresponding rating information for that modified set.

6. The method of claim 5, wherein the revision comprises modification information that is sortable by type of modification, characteristic associated with the modification, or characteristic associated with a user providing a revision; and
further comprising providing the user a sorting function or a searching function to find or select one of the plurality of modified sets of instructions based on a type selected from:
cost associated with following a selected instruction;
estimated time to complete a selected instruction;
component availability for a component needed to compete a selected instruction;
tooling availability for tooling needed to compete a selected instruction; or
likelihood or probability of the instruction set solving a fault or problem associated with the product based on effectiveness information associated with one or more of the modified instruction sets.

7. The method of claim 1, further comprising displaying both the first set of instructions and the second set of instructions simultaneously on a display.

8. The method of claim 1, wherein the revision comprises supplementary information in the form of at least one of written commentary, audio commentary, pictures, and video associated with the performance of one or more portions of the first instruction set.

9. The method of claim 1, wherein the revision comprises supplementary information that indicates a portion of the first instruction set that has a higher probability of mistake or error, and thereby to draw attention and avoid the mistake or error.

10. A controller configured to:
receive, from one or more users of a product, a revision to a first set of instructions associated with the product, the user having one or more associated characteristics; and
modify the first set of instructions based at least in part on the revision to generate a second set of instructions associated with the product

11. The controller of claim 10, wherein the controller is further configured to modify the first set of instructions based at least in part on the one or more associated characteristics.

12. The controller of claim 10, wherein the controller is further configured to determine:
if a number of accepted revisions associated with the user is greater than a threshold number;
if a number of prior submissions of the revision is greater than a threshold number;
if the revision includes a revision of instruction sequence and not a revision of instruction content; and
if a revision acceptance ratio associated with the user is greater than a threshold ratio.

13. The controller of claim 10, wherein the controller is further configured to receive rating information on the second set of instructions from one or more of a plurality of users.

14. The controller of claim 10, wherein the second set of instructions is one of a plurality of modified sets of instructions created from a plurality of revisions provided by users, and each modified set of instructions of the plurality is configured to display corresponding rating information for that modified set.

15. The controller of claim 14, wherein the revision comprises modification information that is sortable by type of modification, characteristic associated with the modification, or characteristic associated with a user providing a revision; and
the controller is further configured to provide the user a sorting function or a searching function to find or select one of the plurality of modified sets of instructions based on a type selected from:
cost associated with following a selected instruction;
estimated time to complete a selected instruction;
component availability for a component needed to compete a selected instruction;
tooling availability for tooling needed to compete a selected instruction; or
likelihood or probability of the instruction set solving a fault or problem associated with the product based on effectiveness information associated with one or more of the modified instruction sets.

16. The controller of claim 10, further comprising a display, and the controller is further configured to display on the display both the first set of instructions and the second set of instructions simultaneously.

17. The controller of claim 10, wherein the revision comprises supplementary information in the form of at least one of written commentary, audio commentary, pictures, and video associated with the performance of one or more portions of the first instruction set.

18. The controller of claim 10, wherein the revision comprises supplementary information that indicates a portion of the first instruction set that has a higher probability of mistake or error, and thereby to draw attention and avoid the mistake or error.

19. A system, comprising:
means for receiving, from one or more users, of a product a revision to a first set of instructions associated with the product, the user having one or more associated characteristics;
means for modifying the first set of instructions based at least in part on the revision to generate a second set of instructions associated with the product; and
means for determining whether to modify the first set of instructions based at least in part on the one or more associated characteristics.

20. The system of claim 19, further comprising:
means for receiving rating information on the second set of instructions from one or more of a plurality of users, and the second set of instructions is one of a plurality of modified sets of instructions created from a plurality of revisions provided by the plurality of users, and each modified set of instructions of the plurality is configured to display corresponding rating information for that modified set.
